(19) United States
(12) Patent Application Publication
(10) Pub. No.: US 2005/0175731 A1
(43) Pub. Date: Aug. 11, 2005

(54) Nozzle for a blow molding machine

(76) Inventor: Fu-Chuan Chiang, Taichung (TW)

Correspondence Address: HERSHKOVITZ & ASSOCIATES, 1725 I STREET NW, SUITE 300, WASHINGTON, DC, 20006, US

(21) Appl. No.: 10/773,216

(22) Filed: Feb. 9, 2004

(51) Int. Cl. B29C 49/58

(52) U.S. Cl. 425/535

(57) ABSTRACT

A nozzle for a blow molding machine has a base, an attachment collar and a head. The base has an inlet and a mouth communicating with the inlet. The attachment collar is attached securely to the base and has a central hole. The head is moveably mounted in the central hole in the attachment collar. The head has a top extending out from the attachment collar and a central passage communicating with the mouth in the base. Part of the bottom of the head corresponds to the mouth. The head will be pushed to move when compressed air is discharged into the nozzle. The position of a semi-finished product mounted around the top of the head can be automatically positioned during a blow molding process.

### BACKGROUND OF THE INVENTION

1. Field of the Invention

The present invention relates to a nozzle for a blow molding machine, and more particularly to a nozzle for a blow molding machine capable of automatically positioning a semi-finished product in a mold to improve the quality of finished products of a blow molding process.

2. Description of Related Art

With reference to FIG. 6, a conventional nozzle for a blow molding machine in accordance with the prior art comprises a base (70), a bottom collar (72), a head (74) and a top collar (76). The base (70) is connected to a compressed air source (not shown) and has a top (not numbered), a bottom (not numbered), an inlet (702) defined in the bottom and a mouth (704). The mouth (704) is conical, is defined in the top of the base (70) and communicates with the inlet (702). The bottom collar (72) is attached securely to the base (70) with bolts (not numbered) and is mounted around the top of the base (70). The head (74) is attached to the top of the base (70) and has a top (not numbered), a bottom (not numbered) and a central passage (742) defined through the head (74) and communicating with the mouth (704) in the base (70). The top collar (76) is attached securely to the bottom collar (72) with bolts (not numbered) and is mounted around the head (70) to securely hold the head (74) on the base (70).

Blow molding comprises mounting a semi-finished product (80) such as a bottle around the top of the head (74), and the nozzle and the semi-finished product are then moved into an opening (not shown) in a mold (not shown) with a molding chamber (not shown) having a specific shape. Compressed air is discharged into the central passage (742) through the inlet (702) and the mouth (704) in the base (70) to expand the semi-finished bottle (80). A finished product (not numbered) such as a bottle will take the shape of the molding chamber in the mold, and the blow molding process is complete when the finished product is removed from the mold.

However, the conventional nozzle has a complex structure and is difficult to assemble and manufacture. The head (74) of the conventional nozzle is attached securely to the top of the base (70) and is immoveable so the position of the semi-finished product is the mold cannot be adjusted with the conventional nozzle. When the semi-finished bottle (80) relative to is inclined relative to the head (74), the shape of the finished bottle will be deformed.

To overcome the shortcomings, the present invention provides a nozzle to mitigate or obviate the aforementioned problems.

### SUMMARY OF THE INVENTION

The main objective of the invention is to provide a nozzle for a blow molding machine that has a simplified structure and is capable of automatically adjusting the position of semi-finished products in a mold to improve the manufacturing quality of finished products of a blow molding process.

The nozzle for a blow molding machine has a base, an attachment collar and a head. The base has a top, a bottom, an inlet defined in the bottom and a mouth defined in the top. The mouth communicates with the inlet and has a first diameter at the top of the base. The attachment collar is securely attached to the top of the base and has a top, a bottom and a central hole defined in the bottom of the attachment collar. The head is moveably mounted in the central hole in the attachment collar. The head has a bottom, a top extending out from the top of the attachment collar and a central passage with a diameter defined through the head, communicating with the mouth in the base and having a second diameter at the bottom of the head. The first diameter of the mouth at the top of the base is larger than the second diameter of the central passage at the bottom of the head to make part of the bottom of the head correspond to the mouth. Accordingly, the head will be pushed upward when compressed air is discharged into the nozzle. The position of the semi-finished bottle mounted around the top of the head can be automatically positioned in a mold.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a nozzle for a blow molding machine in accordance with the present invention;

FIG. 2 is an exploded perspective view of the nozzle in FIG. 1;

FIG. 3 is a cross sectional side plan view of the nozzle in FIG. 1

FIG. 4 is an operational side plan view in cross section of a blow mold with the nozzle in FIG. 1;

FIG. 5 is an operational side plan view in cross section of the mold with the nozzle in FIG. 4 with the head moved upward by compressed air discharged into the nozzle; and

FIG. 6 is an operational side plan view in cross section of a conventional nozzle for a blow molding machine in accordance with the prior art.

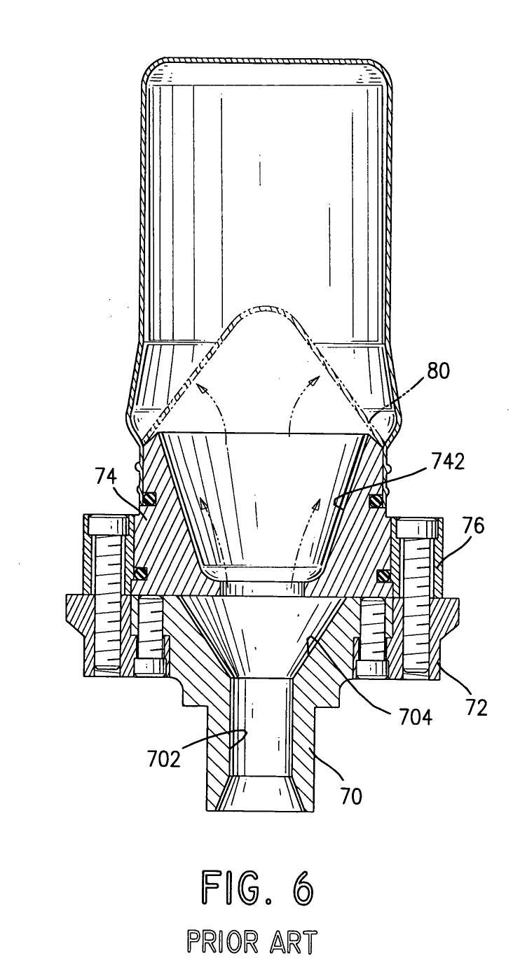

### DETAILED DESCRIPTION OF PREFERRED EMBODIMENT

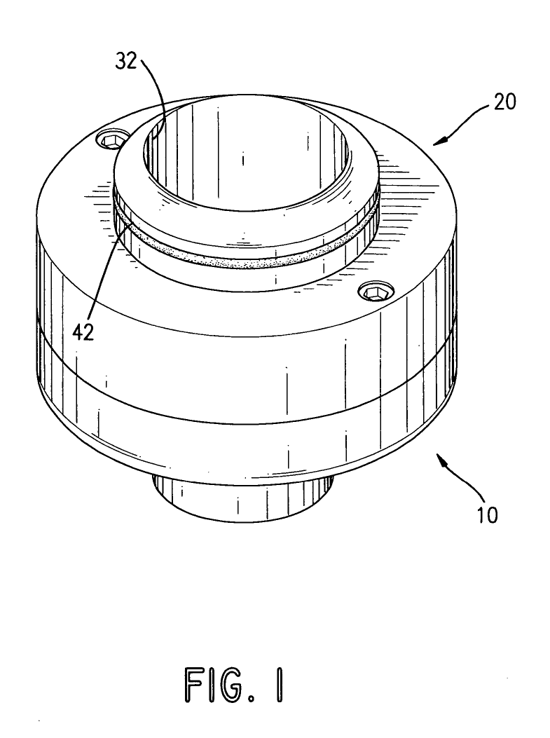

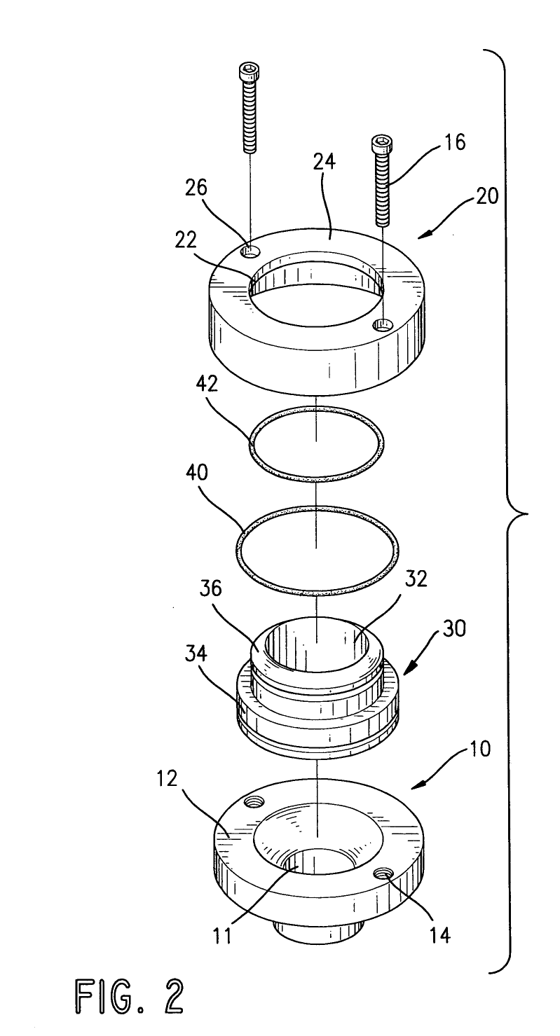

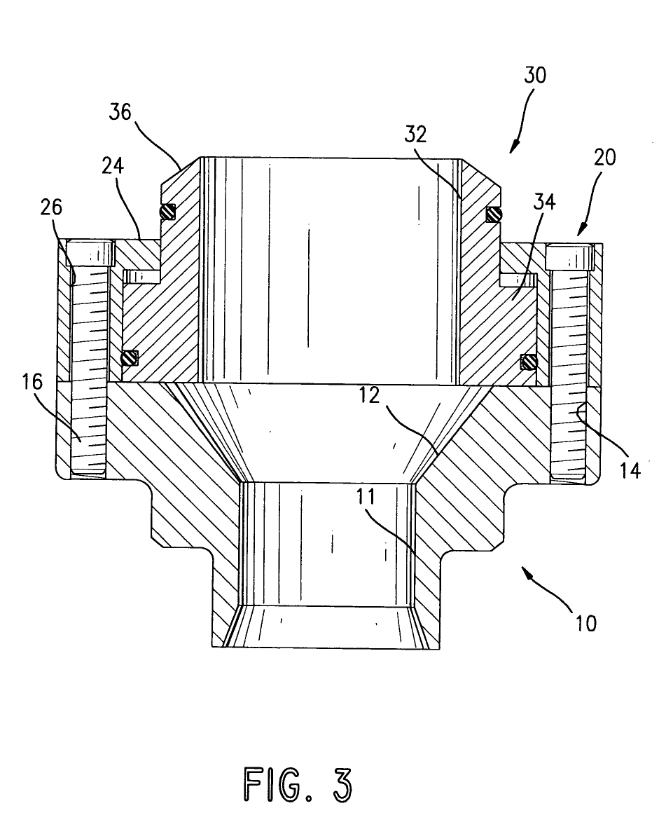

With reference to FIGS. 1 to 3, a nozzle for a blow molding machine in accordance with the present invention comprises a base (10), an attachment collar (20), multiple optional bolts (16), a head (30) and two optional O-rings (40, 42), where the blow molding machine uses an external compressed air source.

The base (10) is connected to a compressed air source (not shown) and has a top (not numbered), a bottom (not numbered), an inlet (11), a mouth (12) and multiple optional threaded holes (14). The inlet (11) is defined in the bottom. The mouth (12) may be conical, is defined in the top, communicates with the inlet (11) and has a first diameter (not numbered) at the top of the base (10). The optional threaded holes (14) are defined in the top of the base (10).

The attachment collar (20) is attached securely to the top of the base (10) and has a top (not numbered), a bottom (not numbered), a central hole (22), a top flange (24) and multiple optional through holes (26). The central hole (22) is defined coaxially through the attachment collar (20), and the (20). The optional through holes (26) are defined longitudinally through the attachment collar (20) and align respectively with the optional threaded holes (14) in the base (10).

The multiple optional bolts (16) pass respectively through the optional through holes (26) in the attachment collar (20) and are screwed respectively into the optional threaded holes (14) in the base (10) to attach the attachment collar (20) securely to the base (10). Alternatively, the attachment collar (20) may be attached to the base (10) by rivets, welding or other conventional means.

The head (30) is mounted moveably in the central hole (22) in the attachment collar (20) and has a bottom (not numbered), a top (not numbered), a central passage (32), a bottom protrusion (34) and an optional chamfer (36). The top of the head (30) extends out the top flange (24) in the attachment collar (20). The central passage (32) is defined longitudinally through the head (30) and communicates with the mouth (12) in the base (10). The central passage (32) has a second diameter at the bottom of the head (30). The first diameter of the mouth (12) at the top of the base (10) is larger than the second diameter of the central passage (32) at the bottom of the head (30) to make part of the bottom of the head (30) correspond to the mouth (12). The bottom protrusion (34) protrudes radially out from the bottom of the head (30). When the head (30) is mounted in the attachment collar (30) and the attachment collar (30) is attached to the base (10), a gap (not numbered) is defined between the top flange (26) of the attachment collar (20) and the bottom protrusion (34) on the head (30). Consequently, the head (30) is moveable inside the attachment collar (20). The optional chamfer (36) is defined around the top of the head (30).

One of the optional O-rings (40) is mounted around the protrusion (34) on the head (30) to prevent compressed air from leaking between the head (30) and the attachment collar (20). The other optional O-ring (42) is mounted around the head (30) near the top of the head (30) to prevent compressed air from leaking between the head (30) and a semi-finished product that is mounted around the head (30) while blow molding is in process.

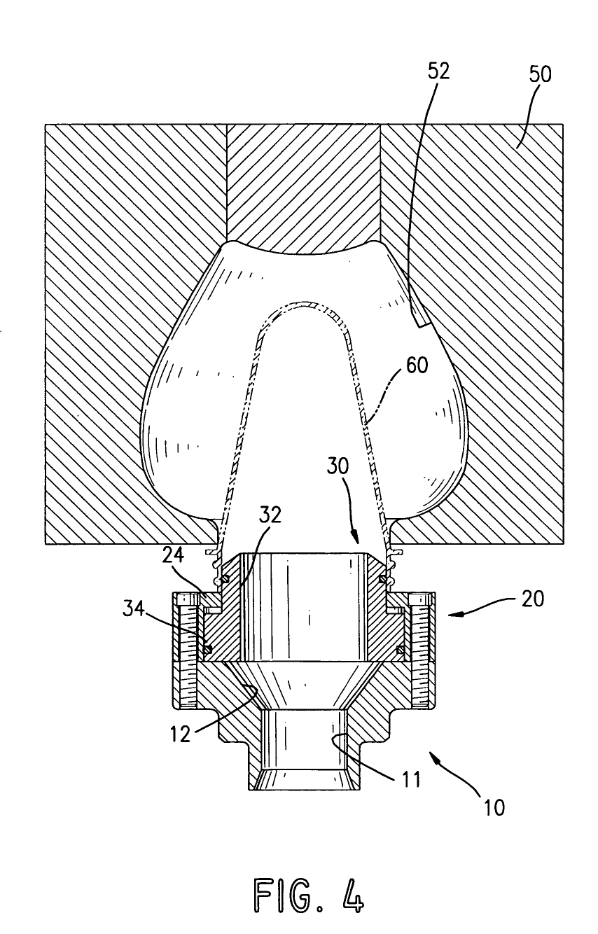

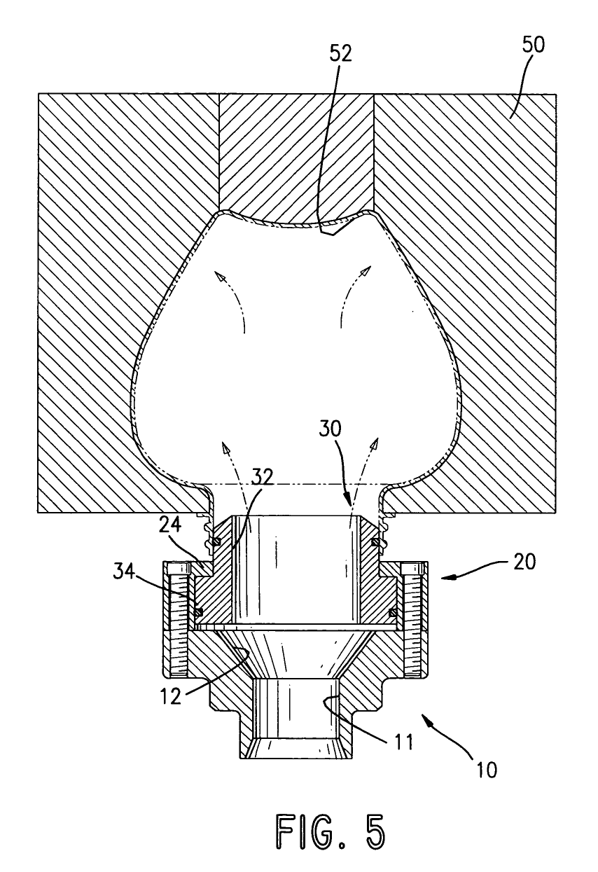

With reference to FIGS. 4 and 5, a blow molding process comprises mounting a semi-finished product (60) around the top of the head (30) of the nozzle, and the nozzle is then inserted into an opening in a mold (50) with a molding chamber (52). The top of the head (30) is slightly separated from the mold (50) to define a gap between the head (30) and the mold (50). Because part of the bottom of the head (30) corresponds to the mouth (12) in the base (10), the head (30) will be pushed and move relative to the attachment collar (20) by compressed air when the compressed air is discharged into the nozzle. Consequently, the semi-finished product (60) will be squeezed between the head (30) and the mold (50) during the blow molding process. Squeezing the semi-finished product (60) will force the semi-finished bottle (60) to move to a desired position. Accordingly, deformation of the bottle can be prevented, and the manufacturing quality of final products of the blow molding process is improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A nozzle for a blow molding machine that uses an external compressed air source comprising:
a base connected to a compressed air source and having a top, a bottom, an inlet defined in the bottom and a mouth defined in the top, communicating with the inlet and having a first diameter at the top of the base;
an attachment collar attached securely to the top of the base and having a top, a bottom, a central hole defined coaxially through the attachment collar and a top flange formed in and extending into the central hole at the top of the attachment collar; and
a head mounted moveably in the central hole in the attachment collar and having a bottom, a top extending out from the top of the attachment collar, a central passage defined longitudinally through the head, communicating with the mouth in the base and having a second diameter at the bottom of the head and a bottom protrusion protruding radially out from the bottom of the head,
wherein the first diameter of the mouth at the top of the base is larger than the second diameter of the central passage at the bottom of the head to make part of the bottom of the head correspond to the mouth.

2. The nozzle as claimed in claim 1, wherein
a gap is defined between the top flange on the attachment collar and the bottom protrusion on the head to make the head moveable relative to the attachment collar.

3. The nozzle as claimed in claim 2 further comprising an O-ring mounted around the protrusion on the head.

4. The nozzle as claimed in claim 2, wherein the head has a chamfer defined around the top of the head.

5. The nozzle as claimed in claim 4 further comprising an O-ring mounted around the head near the top of the head.

6. The nozzle as claimed in claim 5, wherein the base has multiple threaded holes defined in the top of the base;
the attachment collar has multiple through holes defined through the attachment collar and aligning respectively with the threaded holes in the base; and
multiple bolts penetrating respectively through the through holes in the attachment collar and screwed respectively into the threaded holes in the base to securely attach the attachment collar onto the base.

7. The nozzle as claimed in claim 1, wherein the base has multiple threaded holes defined in the top of the base;
the attachment collar has multiple through holes defined through the attachment collar and aligning respectively with the threaded holes in the base; and
multiple bolts penetrating respectively through the through holes in the attachment collar and screwed respectively into the threaded holes in the base to securely attach the attachment collar onto the base.
